(19) United States
(12) Patent Application Publication
(10) Pub. No.: US 2004/0010772 A1
(43) Pub. Date: Jan. 15, 2004

(54) Interactive method and system for faciliting the development of computer software applications

(75) Inventors: Christine McKenna, Avon, CT (US); James Pelletier, Ft. Wayne, IN (US); Ingrid Russell, Danbury, CT (US); Michael Signor, Avon, CT (US); Randy E. Ferree, Phoenixville, PA (US); Jackie A. Holohan, Newington, CT (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: General Electric Company, Schenectady, NY

(21) Appl. No.: 10/065,730

(22) Filed: Nov. 13, 2002

Related U.S. Application Data
(60) Provisional application No. 60/331,230, filed on Nov. 13, 2001.

(51) Int. Cl. G06F 9/44

(52) U.S. Cl. 717/101; 717/120

(57) ABSTRACT

A comprehensive method and system is provided for developing and implementing new computer software applications through a series of distinct stages. Following the completion of each stage, a tollgate meeting is held between the various parties involved and a decision as made on whether the project should be advanced to the next stage. Guidelines, templates and checklist items are provided for each stage in a user-friendly manner over an interactive computer interface, such as a web page. By providing on-line guidance to project developers, the system and method of the present invention substantially decreases the likelihood of errors being made which introduce costs in both time, resources, and risk. Further, the present system, through its comprehensive, global nature, substantially increases the ability for distributed locations to stay in tune with what each other are doing. Because all locations must develop applications in accordance with the above-described system, added consistency results.

### CROSS REFERENCE TO RELATED APPLICATIONS

This application claims the benefit of U.S. provisional patent application No. 60/331,230 filed Nov. 13, 2001, the disclosure of which are incorporated herein by reference.

### BACKGROUND OF THE INVENTION

The present invention relates generally to systems and processes for initiating and implementing changes into business organizations. More particularly, the present invention relates to providing a comprehensive system for facilitating the development and introduction of computer software or other types of information technology (IT) or other computer software projects into a business.

Conventionally, distributed global businesses and corporations have struggled to efficiently and cost effectively develop and introduce new computer software applications for a variety of reasons, such as improper foresight, poor resource and workflow management, etc. In addition to problems caused by the development of specific applications, the various sites which together make up the organization may have, over time, promulgated significantly different methods for developing such applications. These differences further restrict the ability to transition a software application efficiently from one site to another, since the processes involved in qualifying the supplier may differ between sites. Further, a plurality of considerations must be taken into account when determining whether to approve the development and introduction of a new software application. Diverse considerations such as material specification issues, environment health and safety issues, and supplier resource issues all impact the determination regarding a particular potential supplier. Since determinations regarding the various elements related to supplier introduction are necessarily made at multiple levels within the organization, the merging of dissimilar systems and the physical documentation associated with each system further compounds the inefficiency in conventional supplier introduction methods.

Therefore, there is a need in the art of software application development and implementation processes for a comprehensive and interactive method and system for facilitating the efficient development and introduction of such applications. There is a further need for a globalized and uniform software project development and management method across distributed locations.

### SUMMARY OF THE INVENTION

The present invention overcomes the problems noted above, and provides additional advantages, by providing for a comprehensive method and system for developing and implementing new computer software applications through a series of distinct stages. Following the completion of each stage, a tollgate meeting is held between the various parties involved and a decision as made on whether the project should be advanced to the next stage.

Further, guidelines, templates and checklist items are provided for each stage in a user-friendly manner over an interactive computer interface, such as a web page. By providing on-line guidance to project developers, the system and method of the present invention substantially decreases the likelihood of errors being made which introduce costs in both time, resources, and risk. Further, the present system, through its comprehensive, global nature, substantially increases the ability for distributed locations to stay in tune with what each other are doing. Because all locations must develop applications in accordance with the above-described system, added consistency results.

### BRIEF DESCRIPTION OF THE DRAWINGS

The present invention can be understood more completely by reading the following Detailed Description of exemplary embodiments, in conjunction with the accompanying drawings, in which:

FIG. 1 is an internet computer system for use with the system of the present invention.

FIG. 2 is a flow chart describing a preferred general embodiment of a method for developing and introducing a new IT project into an organization.

FIG. 3 is a flow chart describing a discrete collection of project management methodology stages and associated tollgates.

FIG. 4 is a screen shot illustrating one embodiment of a general project management methodology and tollgate selection web page 400.

FIG. 5 is a screen shot illustrating one embodiment of a tollgate 1—specific web page for displaying interactive information relating to stage 300 described in FIG. 3.

FIG. 6 is a screen shot illustrating one embodiment of a tollgate 2—specific web page for displaying interactive information relating to stage 302 described in FIG. 3.

FIG. 7 is a screen shot illustrating one embodiment of a tollgate 3—specific web page for displaying interactive information relating to stage 304 described in FIG. 3.

FIG. 8 is a screen shot illustrating one embodiment of a tollgate 4—specific web page for displaying interactive information relating to stage 306 described in FIG. 3.

FIG. 9 is a screen shot illustrating one embodiment of a tollgate 5—specific web page for displaying interactive information relating to stage 308 described in FIG. 3.

FIG. 10 is a screen shot illustrating one embodiment of a tollgate 6—specific web page for displaying interactive information relating to stage 310 described in FIG. 3.

FIG. 11 is a screen shot illustrating one embodiment of a tollgate 7—specific web page for displaying interactive information relating to stage 312 described in FIG. 3.

### DETAILED DESCRIPTION OF THE PREFERRED EMBODIMENTS

The present invention is directed toward a comprehensive method and system for facilitating the development and introduction of new computer software application projects into a business organization. Although not limited thereto, in one embodiment of the present invention, the system and method are implemented by an interactive computer software system incorporated within a computer-readable medium such as a hard disk drive, an optical medium such as a compact disk, or the like. Further, the medium is preferably available to a plurality of distributed users connected together over a computer network, such as a local area network (LAN), a wide area network (WAN), or the Internet. The inventive computer software system is designed to provide interactive guidelines and templates to project participants to facilitate project development.

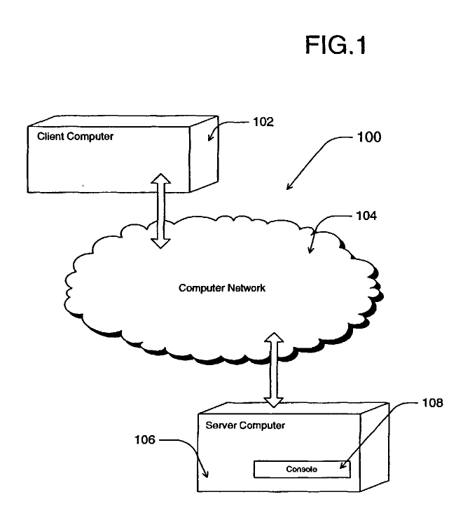

An Internet computer system 100 is generally illustrated in FIG. 1. A conventional client computer system 102, executing a client browser application that supports the HTTP protocol, is connected typically through a network service provider to a suitable computer network 104 such as the Internet.

Client computer system 102 may include, for instance, a personal computer running the Microsoft Windows™ 95, 98, Millenium™, NT™, or 2000, Windows™ CE™, PalmOS™, Unix, Linux, Solaris™, OS/2™, BeOS™, MacOS™ or other operating system or platform. Client computer system 102 may also include a microprocessor such as an Intel x86-based device, a Motorola 68K or PowerPC™ device, a MIPS, Hewlett-Packard Precision™, or Digital Equipment Corp. Alpha ™ RISC processor, a microcontroller or other general or special purpose device operating under programmed control. Furthermore, client computer system 102 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. Client computer system 102 may also include a network-enabled appliance such as a WebTV™ unit, radio-enabled Palm™ Pilot or similar unit, a set-top box, a networkable game-playing console such as Sony Playstation™ or Sega Dreamcast™, a browser-equipped cellular telephone, or other TCP/IP client or other device.

In addition to the Internet, suitable computer networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.92, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, computer network 104 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Computer network 104 may yet further include or interface with any one or more of an RS-232 serial connection, an IEEE-1394 (Firewire™) connection, a Fibre Channel connection, an IrDA (infrared) port, a SCSI (Small Computer Systems Interface) connection, a USB (Universal Serial Bus) connection or other wired or wireless, digital or analog interface or connection.

A server computer system 106 is also coupled typically through an Internet Service Provider to the computer network 104. The server computer system 106 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The server computer system 106, controlled by a local console 108, executes at least one web server application conventionally known as a HTTPd server. In addition, the server computer system 106 preferably provides local storage for at least one, though typically many, web pages as files in HTML format and/or other formats. Preferably, a plurality of pricing schedules are also stored in the memory device of server computer system 106. These various pricing schedules are described in additional detail below. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A protocol_identifier of http specifies the conventional hyper-text transfer protocol. A URL request for a secure Internet communication session typically utilizes the secure protocol identifier https, assuming that the client browser and web server each support and implement the secure sockets layer (SSL). The server_path is typically of the form prefix.domain, where the prefix is typically www to designate a web server and the domain is the standard Internet sub-domain.top-level-domain of the server system 106. The optional web_page_path is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the computer network 104.

The URL issued from the client system 102 may also be of a complex form that identifies a common gateway interface (CGI) program on a server system 106. Such a HTML hyperlink reference is typically of the form:

<form action=http://www.vendor.com/cgi-bin/logon.cgi method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

Preferably, the method and system described below is implemented by a computer software program, such as a web server application, resident on one or more server computers (such as server computer system 106, described above) associated with a content provider. Preferably, such a web server application is utilized to create and maintain a plurality of dynamically interactive web pages on the server computer(s). In a preferred embodiment, users of the system are connected to the server-hosted web pages through the browser applications (e.g., Microsoft Internet Explorer™ and Netscape Navigator®) of a plurality of client computers (such as client computer system 102) over the computer network 104. In this manner, system users may remotely interact with the servers to obtain, exchange, or modify information as more fully set forth in detail below.

Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

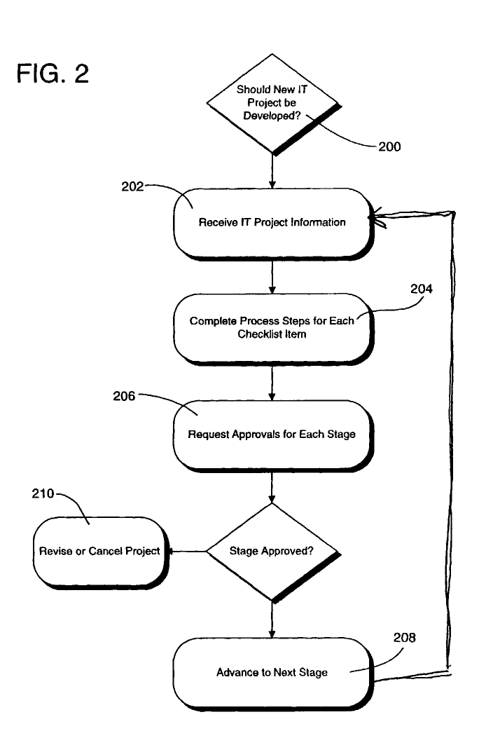

Referring now to FIG. 2, there is shown a flow chart describing a preferred general embodiment of a method for developing and introducing a new IT project into an organization. In a first step 200, an organization makes an initial determination as to whether or not a new IT project should be developed. Preferably, the information used in this determination includes the scope and objectives of the project, the cost of the project, as well as the resources, timing, and potential risks associated with the project. In step 202, information regarding the proposed IT project is generated, received, identified, and analyzed in accordance with the present invention. As described in additional detail below, step 202 involves progressing through a series stages relating to discrete components of the new project development process. In a preferred embodiment, each of the various process stages include a plurality of checklist elements and required milestones prior to stage completion. In step 204, process steps are completed for each required checklist item. Next, in step 206, approvals are requested for each stage of the project development process. If an approval for a particular stage is obtained, the status of that stage is changed to complete and the process is advanced into the next stage in step 208. However, if approval is not obtained, the status is not changed, and the project must be either revised or canceled in step 210.

By providing a single comprehensive system for guiding the development process, an organization is better able to ensure that proper efforts and safeguards were taken in developing and introducing the new IT project, thus substantially reducing risk and increasing transition efficiency. Further, a universal, integrated system allows the potentially disparate working environments of global organizations to better operate as an integrated unit. In particular, requiring the supplier introduction process to systematically progress through a system of stages, checklists and milestones as well as the required approvals at each stage substantially assists an organization's ability to rapidly and accurately assess the best manner of developing, testing and implementing new projects.

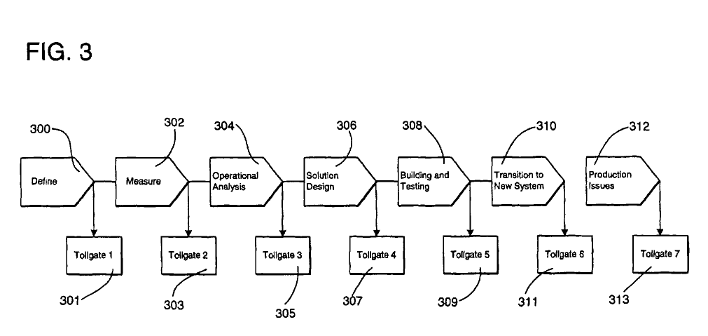

Referring now to FIG. 3, there is disclosed a flow chart describing a discrete collection of project management methodology stages and associated tollgates. In particular, a preferred embodiment of the present system includes seven discrete stages specifically related to: 1) project definition (300); 2) project measurement (302); 3) operational analysis (304); 4) solution design (306); 5) building and testing (308); 6) transition to new system (310); and 7) production issues (312). Prior to advancing from one stage to the next, at least one approver must approve the advancement. It should be understood however, that although formal advancement from one stage to the next requires tollgate approval, information may be simultaneously obtained for multiple stages so as to expedite the overall project development and implementation process. This approval process is generally referred to as a tollgate. Accordingly, for the above-described seven stage embodiment, there are provided seven discrete tollgates, 301, 303, 305, 307, 309, 311 and 313, each of which must be passed before the project can advance to the next stage in its development.

As briefly alluded to above, in one embodiment of the present invention, the overall project development and implementation process is completed through a series of stages, actions, milestones, checklists, and tollgates. For each of the above stages 300, 302, 304, 306, 308, 310 and 312, there are preferably provided a plurality of milestone items for each of a plurality of actors. Further, each of the various milestone items further includes a plurality of checklist items designed to meet the requirements of the milestone. As will be clearly understood from the description below, not all checklist items provided for a particular milestone will be applicable to every scenario. In these cases, completion of the item will not be required. However, once all of the required information has been gathered/received for each milestone in the stage, a stage tollgate is held, whereby a determination is made regarding whether the project will be advanced to the next stage.

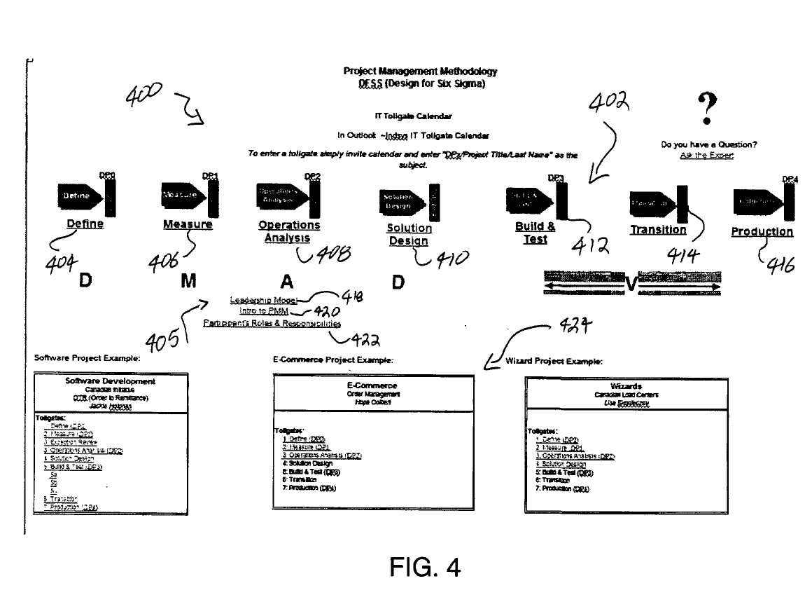

Referring now to FIG. 4, there is shown a screen shot illustrating one embodiment of a general project management methodology and tollgate selection web page 400. As mentioned above, each web page of a web site is designed to include various related pieces of information as well as interactive hyperlinks directing users toward additional related information. In the embodiment of FIG. 4, web page 400 is may be further broken down into a variety of information sections. In particular, a tollgate selection section 402 is provided for itemizing and briefly describing the various tollgates available for selection and described briefly above. In addition to descriptive information, the tollgate selection section also provides hyperlinks to dedicated web pages for each available tollgate section. Hyperlink 404 relates to tollgate 1: Define. Hyperlink 406 relates to tollgate 2: Measure. Hyperlink 408 relates to tollgate 3: Operations Analysis. Hyperlink 410 relates to tollgate 4: Solution Design. Hyperlink 412 relates to tollgate 5: Build and Test. Hyperlink 414 relates to tollgate 6: Transition. Hyperlink 416 relates to tollgate 7: Production.

Additionally, a PMM information section 405 is also preferably provided on web page 400. The PMM information section 405 includes a plurality of hyperlinks 418, 420, and 422, the selection of which results in the display of background and other descriptive information relating to the project management methodology. As shown in FIG. 4, hyperlink 418 relates to a Leadership Model web page, hyperlink 420 relates to a Introduction to PMM web page and hyperlink 422 relates to a Participants' Roles and Responsibilities web page.

In one embodiment of the present invention, participants in the PMM preferably include the following: CIO for participating in the tollgate reviews, insuring that the project is aligned with the business goals and the IT strategy by leading the review; a Guidance Team for participating in the tollgate reviews and insuring the project is aligned with the business goals and the processes within the function the project supports; a Program Leader responsible for all aspects of the project (execution to plan and budget) including the scheduling of all tollgate reviews and the use of this methodology, arranging exception review when budget or plans change and jeopardize the budget or schedule, and communicating the latest status to the CEO in Quarterly IT Program reviews; a Development Leader responsible for the development of the system to support the business processes, monitoring the development of conversion and interface programs from the legacy environment; an Integration Leader having responsibility for the global business processes across the implementation, ensuring that the project delivers DFSS business solution and benefits, drives change throughout the enterprise, working with the business sponsor, provides systems planning and prioritization of needs, and maintains relationships with Guidance teams, Business Leaders, and CIG; an Implementation Leader for developing and managing a total project implementation strategy and software rollout schedule to achieve project commitments, develops and maintains a change management strategy to support the business processes at each site, coordinates training requirements across all implementations—OR—leads the transition to a production environment for all sites effected (rollout schedule, change management strategy, training requirements); Team Leaders for supporting the production system including resolution of all applications, interfaces, databases, operating systems, and hardware problems, decommissions legacy systems and ensures integration with the development and deployment teams; Functional Analysts for ensuring the functionality of the system meets the business requirements, leading the process mapping of the business processes (As Is and To Be) and the development of the business policies and procedures to support the system implementation; Six Sigma Quality having responsibility for training and mentoring the project team in the use of this methodology and six sigma tools to meet the business requirements (CTQs); Vendor Project Managers for managing the vendor's project team to meet the business requirements by closing the gaps in functionality of the vendor's solution or identifying alternate solutions; and Lead Vendor Consultants having responsibility for the daily activities in support and development of the business solution and leading the vendor's development team in any changes generated by the business needs.

A project examples section 424 is also preferably provided for including information and hyperlinks related to various examples of the PMM as practically implemented.

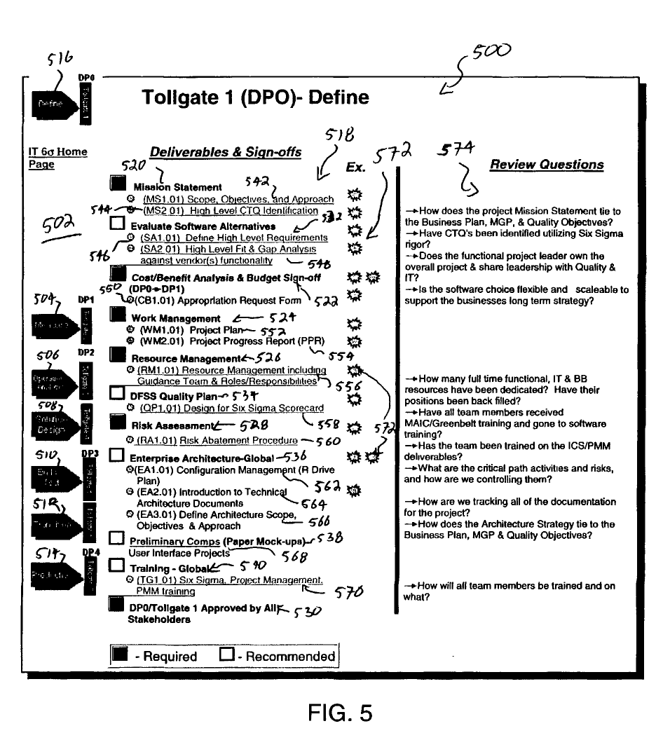

Referring now to FIG. 5, there is shown a screen shot illustrating one embodiment of a tollgate 1—specific web page 500 for displaying interactive information relating to stage 300 described briefly above. As referenced above, the tollgate 1 web page 500 is displayed in response to the selection of hyperlink 404 of the general project management methodology and tollgate selection web page 400.

In the embodiment of FIG. 5, there are displayed several discrete sections collectively enabling users to follow the methodology related to tollgate 1. A left side navigation bar 502 is provided for enabling users to easily move between web pages relating to the various tollgates 1-7. Selection of tollgates is made by selecting hyperlinked images 504-514 relating to each of the remaining 6 tollgate choices. In the displayed embodiment, an image 516 representative of the currently selected tollgate is presented at the top of the bar.

A deliverables and sign-offs section 518 is also provided on web page 500 for itemizing a plurality of required and recommended methodology options. In accordance with the displayed embodiment of the present invention, the following elements are required in performing the program management methodology: mission statement 520, cost/benefit analysis and budget sign-off 522, work management 524, resource management 526, risk assessment 528, and tollgate approval 530. Additionally, the following elements, although not required, are recommended for completion in furtherance of the overall methodology goals: alternative software evaluation 532, design for six sigma(DFSS) (an efficiency methodology relating to reducing errors in all facets of business) 534, a breakdown of the global enterprise architecture 536, any preliminary mock-ups 538 for the project, and any identified training systems which have been developed 540.

In addition to the discrete methodology elements described above, each element typically includes at least one sign-off document related thereto, wherein the sign-off documents are completed and forwarded to a tollgate approval team prior to advancing to the next tollgate. Exemplary sign-off documents are described as follows for each of the various required and recommended methodology options described above. It should be understood however, that this listing is illustrative only and that various modifications thereto are also included within the scope of the present invention. For the mission statement element 520, a Scope, Objectives, and Approach sign-off 542 is provided preferably including a hyperlink directing users to a template document related specifically to the formation and completion of a mission statement document. Next, a High Level CTQ (critical to quality) Identification sign-off 544 is provided. As with sign-off 542, sign-off 544 is likewise preferably provided with a hyperlink, the selection of which directs users to a template document for assisting users in compiling and documenting critical requirements for the project.

For the alternative software evaluation methodology element 532, sign-offs and hyperlinks are preferably provided for defining high level requirements 546 and preparing a high level fit and gap analysis against vendor functionality 548. The hyperlinks associated with these sign-offs preferably direct users to high level requirements and vendor evaluation templates which may be utilized in fulfilling these sign-offs. As mentioned above, the alternative software evaluation methodology element 532 is not required in the overall system, but is recommended as facilitating the dissemination and review of this information.

For the cost/benefit analysis and budget sign-off methodology element 522, an appropriations request form sign-off 550 is provided with a hyperlink directing users to a template form. For the work management methodology element 524, sign-offs are provided for developing project plan (PP) 552 and a project progress report (PPR) 554. Each of these sign-offs is likewise provided with a hyperlink directing users to template versions of each of these forms.

For the resource management methodology element 526, a sign-off 556 is provided relating to research management and establishing a guidance team and preparing a listing of roles and responsibilities for the team. A corresponding hyperlink directs users to a template document for facilitating the collection of such information. For the DFSS methodology element 534, a sign-off 558 is provided directed to preparing a DFSS scorecard for enabling users and tollgate reviewers to easily identify the six sigma status of the present project. The hyperlink associated with sign-off 558 directs users to a template scorecard which may be used in creating a project-specific version.

For the risk assessment methodology element 528, a sign-off 560 is provided for establishing a risk abatement procedure. An associated hyperlink directs users to a risk abatement template document for aiding in the creation of such a procedure. The global enterprise architecture methodology element 536 includes sign-offs 562, 564, and 566 relating to management configuration, initial technical architecture documentation, and defining the scope, objectives and approach for the project architecture, respectively. For the preliminary mock-ups methodology element 538, a User Interface sign-off 568 is preferably include.

Regarding the training systems methodology element 540, sign-off 570 is provided relating to establishing six sigma, and project management methodology training methods. An associated hyperlink directs users to a global training template useable in creating such training methods for the current project.

In addition to hyperlinks directing users to templates relating to the various methodology elements and sign-offs, additional hyperlinks illustrated generally at numeral 572 may be utilized to direct users to additional information helpful in completing the various method steps. One suitable type of information may include examples of properly completed documents.

A third discrete section of the tollgate 1 web page 500 is a Review Questions section 574. This section is dedicated to itemizing a plurality of tollgate specific questions that should be asked by reviewers prior to approving the tollgate. In the embodiment of FIG. 5, the following review questions are stated: How does the project Mission Statement tie to the Business Plan, MGP, & Quality Objectives?; Have CTQ's been identified utilizing Six Sigma rigor?; Does the functional project leader own the overall project & share leadership with Quality & IT?; Is the software choice flexible andto support the businesses long term strategy?; How many full time functional, IT & BB resources have been dedicated?; Have their positions been back filled?; Have all team members received MAIC/Greenbelt training and gone to software training?; Has the team been trained on the ICS/PMM deliverables?; What are the critical path activities and risks, and how are we controlling them?; How are we tracking all of the documentation for the project?; How does the Architecture Strategy tie to the Business Plan, MGP & Quality Objectives?; and How will all team members be trained and on what?. Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

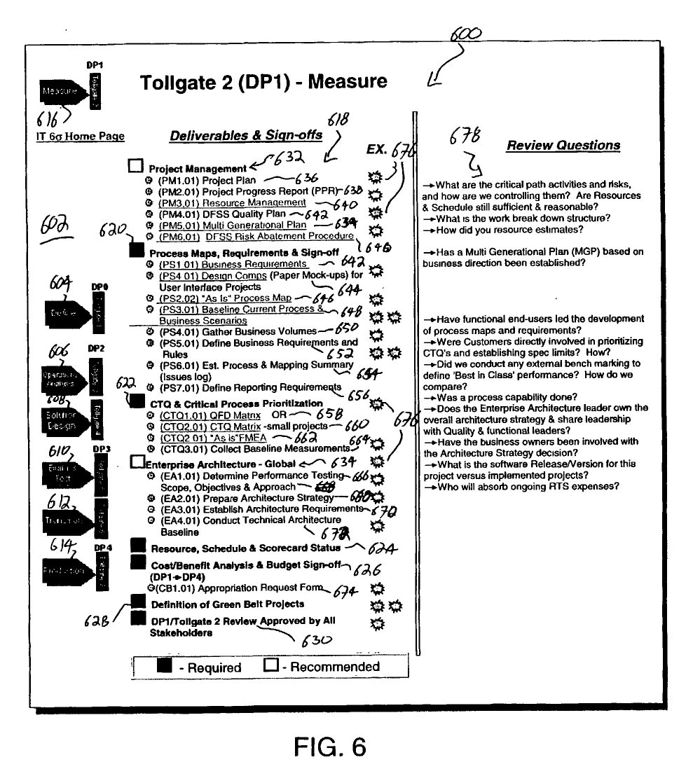

Moving now to FIG. 6, there is shown a screen shot illustrating one embodiment of a tollgate 2—specific web page 600 for displaying interactive information relating to stage 302 described briefly above. As referenced above, the tollgate 2 web page 600 is displayed in response to the selection of hyperlink 406 of the general project management methodology and tollgate selection web page 400.

In the embodiment of FIG. 6, as with the embodiment of the tollgate 1 web site 600 displayed in FIG. 5, there are displayed several discrete sections collectively enabling users to follow the methodology related to tollgate 2. The left side bar 602 is provided for enabling users to easily move between web pages relating to the various tollgates 1-7. Selection of tollgates is made by selecting hyperlinked images 604-614 relating to each of the remaining 6 tollgate choices. In the displayed embodiment, an image 616 representative of the currently selected tollgate is presented at the top of the bar.

As above, a deliverables and sign-offs section 618 is also provided on web page 600 for itemizing a plurality of required and recommended methodology options. In accordance with the displayed embodiment of the present invention, the following elements are required in performing the program management methodology: process maps, requirements and sign-off 620, CTQ and critical process prioritization 622, resource, schedule and scorecard status 624, cost/benefit analysis and budget sign-off 626, definition of green belt projects 628, and tollgate approval 630. Additionally, the following elements, although not required, are recommended for completion in furtherance of the overall methodology goals: project management 632, and a breakdown of the global enterprise architecture 634.

In addition to the discrete methodology elements described above, each element typically includes at least one sign-off document related thereto, wherein the sign-off documents are completed and forwarded to a tollgate approval team prior to advancing to the next tollgate. For the project management element 632, a project plan (PP) sign-off 636 is provided relating specifically to the formation, completion, or updating of a properly formatted PP. Next, a project progress report (PPR) sign-off 634 is provided for requiring the completion or update of a PPR.

A resource management sign-off 636 is provided relating to establishing a organizational plan for managing resources for the project. A hyperlink associated with the sign-off 636 preferably directs users to a template for such a plan. Next, a DFSS quality plan sign-off 638 is next provided directed to preparing or update a DFSS quality plan for enabling users and tollgate reviewers to easily identify the six sigma plans for the present project. Next, a multi-generational project plan (MGPP) sign-off 639 is provided relating to the creation of a project plan specifying various stages of release. A hyperlink associated with the MGPP sign-off directs users to a MGPP template. A DFSS risk abatement procedure sign-off 640 is provided for establishing or updating a risk abatement procedure. An associated hyperlink directs users to a risk abatement template document for aiding in the creation/update of such a procedure.

Turning now to the process maps, requirements and sign-off methodology element 620, a plurality of sign-offs are provided to ensure that projects meet the requirements of the methodology. First, a business requirements OLE_LINK1 sign-off OLE_LINK1642 is provided relating to creating a document specifying the objective requirements of the project, from a business standpoint. Preferably, a hyperlink associated therewith directs users to an example template of a suitable business requirements document. Next, a design comps sign-off 644 is provided for ensuring that a paper mock-up of the project at the design stage has been created. Preferably, a hyperlink associated with sign-off 644 directs users to a template or example mock-up. An as is process map sign-off 646 is included to remind users to provide a process map for the project at it's current stage and includes a hyperlink preferably directing users to a template for creating such a document.

Next, a baseline current process and business scenarios sign-off 648 is included for ensuring that a document is creating depicting the departure of the project from the current process in place and the benefits obtained therefrom. Preferably a hyperlink is included for directing users to an example or template for creating such a document. A gather business volumes sign-off 650 is next providedOLE_LINK2.OLE_LINK2 A define business requirements and rules sign-off 652 is provided to require documentation regarding any defined business requirements and rules for the project. An issue log (Est. process and mapping summary) sign-off 654 is provided relating to a document for tracking any issues or problems which come up during the development of the project. Preferably, a hyperlink is provided for directing users to a template or example version of such an issue log. Next, a define reporting requirements sign-off 656 is provided to ensure that the reporting requirements for each element of project development have been adequately established.

Turning now to the CTQ and critical process prioritization methodology element 622, various associated sign-offs are provided to support the identification and definition of the critical process and elements to the project. Initially, a QFD matrix sign-off 658 is provided for ensuring that users in complete a QFD matrix for the present project. Next, a CTQ Matrix-small projects sign-off 660 is provided similar to sign-off 658, but specifically designed for small projects. In one embodiment, users may optionally select between the QFD matrix or the small project matrix. An As is FMEA sign-off 662 is next provided for assisting users in preparing an as is FMEA. A collect baseline measurements sign-off 664 is also provided for ensuring that baseline measurement information is properly collected for review.

Referring now to the enterprise architecture methodology element 624, there is initially provided a determine performance testing scope, objectives and approach sign-off 666 for ensuring the completion of project testing criteria. Next, a prepare architecture strategy sign-off 668 is provided for establishing an architecture strategy for the current project. An establish architecture requirements sign-off 670 ensures that the architecture requirements for the project have been established. A conduct technical architecture baseline sign-off 672 refers to the creation of baseline measurements for the technical requirements of the project architecture.

Referring to the resource, schedule and scorecard status methodology element 624, the definition of green belt projects methodology element 628, and the tollgate approval methodology element 630, individual sign-offs relating to tollgate 2 have not been provided. However, it should be understood that any steps or information which may be helpful or required to facilitate completion of these elements is included within the scope of the present invention.

Relating to the cost/benefit analysis and budget sign-off methodology element 626, an appropriation request form sign-off 674 is provided relating to requests for resources and other budgeted elements relating to the project. Preferably, a hyperlink is associated with sign-off 674 directing users to a template example of such a form.

In addition to hyperlinks directing users to templates relating to the various methodology elements and sign-offs, additional hyperlinks illustrated generally at numeral 676 may be utilized to direct users to additional information helpful in completing the various method steps. One suitable type of information may include examples of properly completed documents.

A third discrete section of the tollgate 2 web page 600 is a Review Questions section 678. This section is dedicated to itemizing a plurality of tollgate specific questions that should be asked by reviewers prior to approving the tollgate. In the embodiment of FIG. 6, the following review questions are stated: What are the critical path activities and risks, and how are we controlling them?Are Resources & Schedule still sufficient & reasonable?; What is the work break down structure?; How did you resource estimates?; Has a Multi Generational Plan (MGP) based on business direction been established?; Have functional end-users led the development of process maps and requirements?; Were Customers directly involved in prioritizing CTQ's and establishing spec limits?How?; Did we conduct any external bench marking to define ‘Best in Class’ performance?How do we compare?; Was a process capability done?; Does the Enterprise Architecture leader own the overall architecture strategy & share leadership with Quality & functional leaders?; Have the business owners been involved with the Architecture Strategy decision?; What is the software Release/Version for this project versus implemented projects?; and Who will absorb ongoing RTS expenses?. Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

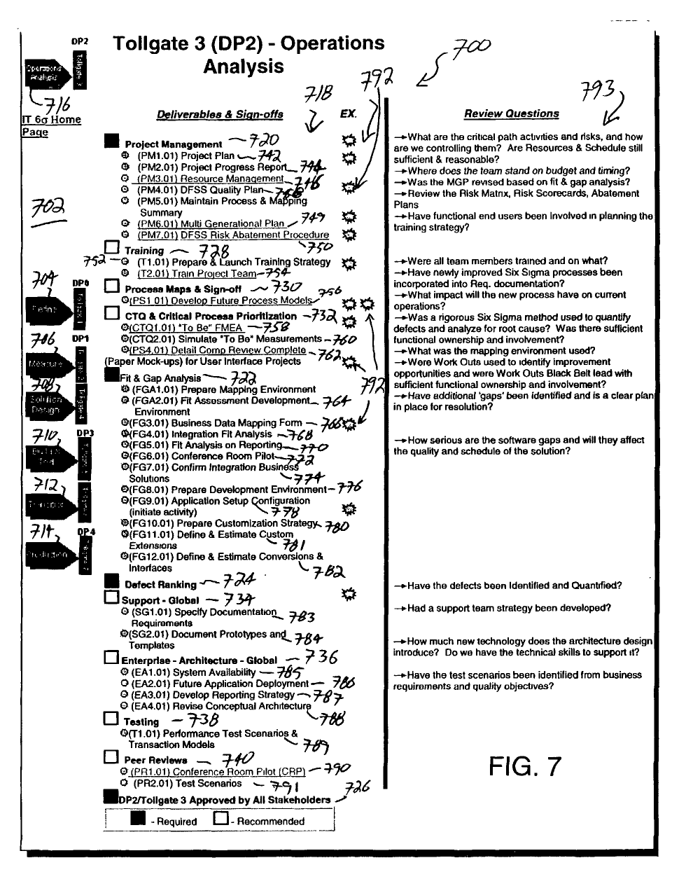

Referring now to FIG. 7, there is shown a screen shot illustrating one embodiment of a tollgate 3—specific web page 700 for displaying interactive information relating to stage 304 described briefly above. As referenced above, the tollgate 3 web page 700 is displayed in response to the selection of hyperlink 408 of the general project management methodology and tollgate selection web page 400.

In the embodiment of FIG. 7, there are displayed several discrete sections collectively enabling users to follow the methodology related to tollgate 3. The left side navigation bar 702 is provided for enabling users to easily move between web pages relating to the various tollgates 1-7. Selection of tollgates is made by selecting hyperlinked images 704-714 relating to each of the remaining 7 tollgate choices. In the displayed embodiment, an image 716 representative of the currently selected tollgate is presented at the top of the bar.

As above, a deliverables and sign-offs section 718 is also provided on web page 700 for itemizing a plurality of required and recommended methodology options. In accordance with the displayed embodiment of the present invention, the following methodology elements are required in performing the program management methodology: project management 720, fit and gap analysis 722, defect ranking 724, and tollgate approval 726. Additionally, the following elements, although not required, are recommended for completion in furtherance of the overall methodology goals: training 728, process maps and sign-off 730, CTQ and critical process prioritization 732, support 734, enterprise architecture 736, testing 738 and peer reviews 740.

In addition to the discrete methodology elements described above, each element typically includes at least one sign-off document related thereto, wherein the sign-off documents are completed and forwarded to a tollgate approval team prior to advancing to the next tollgate. For the project management element 720, a project plan (PP) sign-off 742 is provided relating specifically to the formation, completion, or updating of a properly formatted PP. Next, a project progress report (PPR) sign-off 744 is provided for requiring the completion or update of a PPR.

A resource management sign-off 746 is provided relating to establishing a organizational plan for managing resources for the project. A hyperlink associated with the sign-off 746 preferably directs users to a template for such a plan. Next, a DFSS quality plan sign-off 748 is next provided directed to preparing or update a DFSS quality plan for enabling users and tollgate reviewers to easily identify the six sigma plans for the present project. Next, a multi-generational project plan (MGPP) sign-off 749 is provided relating to the creation of a project plan specifying various stages of release. A hyperlink associated with the MGPP sign-off directs users to a MGPP template. A DFSS risk abatement procedure sign-off 750 is provided for establishing or updating a risk abatement procedure. An associated hyperlink directs users to a risk abatement template document for aiding in the creation/update of such a procedure.

Turning now to the training methodology element 728, there is preferably provided a prepare and launch training strategy sign-off 752 for ensuring that an appropriate training strategy has been developed. Next, a train project team sign-ff 754 is provided relating to the completion of actual training for the team involved in the project. Preferably, a hyperlink associated with sign-off 754 directs users to a template or guidelines document for assisting in the completion of this training.

Referring to the process maps, requirements and sign-off methodology element 730, a develop future process models sign-off 756 is provided to ensure that future models have been developed in accordance with the overall methodology.

Turning now to the CTQ and critical process prioritization methodology element 732, various associated sign-offs are provided to support the identification and definition of the critical process and elements to the project. Initially, a To Be FMEA sign-off 758 is provided for assisting users in preparing a to be FMEA. A simulate to be measurements sign-off 760 is next provided for ensuring that such to be measurements have been properly simulated. A complete detail comp review for user interface projects sign-off 762 is next provided for ensuring that, for user interface projects, the comp review (paper mock-ups) has been completed. Preferably, a hyperlink is associated with sign-off 762 for directing users to a guideline document for assisting in the completion of the review.

Referring now to the fit and gap analysis methodology element 722 Prepare Mapping Environment, the following sign-offs are provided for ensuring that all fit and gap analysis steps have been properly performed. Such sign-offs preferably include, a fit assessment development environment sign-off 764; a business data mapping form sign-off 766; an integration fit analysis sign-off 768; a fit analysis on reporting sign-off 770; a conference room pilot sign-off 772; a confirm integration business solutions sign-off 774; a prepare development environment sign-off 776; an application setup configuration (initiate activity) sign-off 778; a prepare strategy sign-off 780; a define and estimate custom extensions sign-off 781; and a define and estimate conversions and interfaces sign-off 782.

Referring now to the support methodology element 734, a specify documentation requirements sign-off 783 and a document prototypes and templates sign-off 784 are provided for ensuring that the properly type of support documentation is completion. Regarding the enterprise architecture methodology element 736, there is initially provided a system availability sign-off 785 for ensuring the documentation of system availability requirements. Next, a future application deployment sign-off 786 is provided for establishing any envisioned future deployments. A develop reporting strategy sign-off 787 ensures that the reporting methods and strategy has been established. A revise conceptual architecture sign-off 788 refers to the updating/revision of any conceptual architecture that has been created for the current project.

Turning now to the testing methodology element 738, there is provided a performance test scenarios and transaction models sign-off 789 relating to the completion of any needed performance testing scenarios and models. Regarding the peer review methodology element 740, a conference room pilot (CRP) sign-off 790 and a test scenarios sign-off 791 are provided for ensuring that proper peer review the project methodology has been established. Preferably, a hyperlink associated with sign-off 790 directs users to a peer review template document.

As above in relation to tollgates 1 and 2, in addition to hyperlinks directing users to templates relating to the various methodology elements and sign-offs, additional hyperlinks illustrated generally at numeral 792 may be utilized to direct users to additional information helpful in completing the various method steps. One suitable type of information may include examples of properly completed documents.

A third discrete section of the tollgate 3 web page 700 is a Review Questions section 793. This section is dedicated to itemizing a plurality of tollgate specific questions that should be asked by reviewers prior to approving the tollgate. In the emboFullsaveFullsavediment of FIG. 7, the following review questions are stated: What are the critical path activities and risks, and how are we controlling them?Are Resources & Schedule still sufficient & reasonable?; Where does the team stand on budget and timing?; Was the MGP revised based on fit & gap analysis?; Review the Risk Matrix, Risk Scorecards, Abatement Plans; Have functional end users been involved in planning the training strategy?; Were all team members trained and on what?; Have newly improved Six Sigma processes been incorporated into Req. documentation?; What impact will the new process have on current operations?; Was a rigorous Six Sigma method used to quantify defects and analyze for root cause?Was there sufficient functional ownership and involvement?; What was the mapping environment used?; Were Work Outs used to identify improvement opportunities and were Work Outs Black Belt lead with sufficient functional ownership and involvement?; Have additional ‘gaps’ been identified and is a clear plan in place for resolution?; How serious are the software gaps and will they affect the quality and schedule of the solution?; Have the defects been Identified and Quantified?; Had a support team strategy been developed?; How much new technology does the architecture design introduce?Do we have the technical skills to support it?; and Have the test scenarios been identified from business requirements and quality objectives? Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

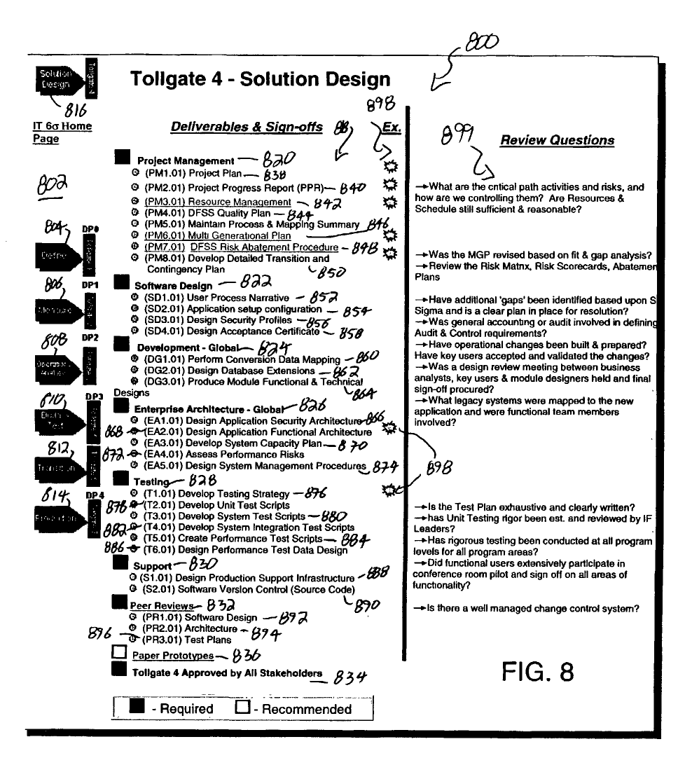

Referring now to FIG. 8, there is shown a screen shot illustrating one embodiment of a tollgate 4—specific web page 800 for displaying interactive information relating to stage 306 described briefly above. As referenced above, the tollgate 4 web page 800 is displayed in response to the selection of hyperlink 410 of the general project management methodology and tollgate selection web page 400.

In the embodiment of FIG. 8, there are displayed several discrete sections collectively enabling users to follow the methodology related to tollgate 4. The left side navigation bar 802 is provided for enabling users to easily move between web pages relating to the various tollgates 1-7. Selection of tollgates is made by selecting hyperlinked images 804-814 relating to each of the remaining 7 tollgate choices. In the displayed embodiment, an image 816 representative of the currently selected tollgate is presented at the top of the bar.

As above, a deliverables and sign-offs section 818 is also provided on web page 800 for itemizing a plurality of required and recommended methodology options. In accordance with the displayed embodiment of the present invention, the following methodology elements are required in performing the program management methodology: project management 820, software design 822, global development 824, global enterprise architecture 826, testing 828, support 830, peer review 832, and tollgate approval 834. Additionally, a paper prototypes element 836, although not required, is also recommended for completion in furtherance of the overall methodology goals.

In addition to the discrete methodology elements described above, each element also typically includes at least one sign-off document related thereto, wherein the sign-off documents are completed and forwarded to a tollgate approval team prior to advancing to the next tollgate. For the project management element 820, a project plan (PP) sign-off 838 is provided relating specifically to the formation, completion, or updating of a properly formatted PP. Next, a project progress report (PPR) sign-off 840 is provided for requiring the completion or update of a PPR.

A resource management sign-off 842 is provided relating to establishing a organizational plan for managing resources for the project. A hyperlink associated with the sign-off 842 preferably directs users to a template for such a plan. Next, a DFSS quality plan sign-off 844 is next provided directed to preparing or update a DFSS quality plan for enabling users and tollgate reviewers to easily identify the six sigma plans for the present project. Next, a multi-generational project plan (MGPP) sign-off 846 is provided relating to the creation of a project plan specifying various stages of release. A hyperlink associated with the MGPP sign-off directs users to a MGPP template. A DFSS risk abatement procedure sign-off 848 is provided for establishing or updating a risk abatement procedure. An associated hyperlink directs users to a risk abatement template document for aiding in the creation/update of such a procedure. Lastly, a develop detailed transition and contingency plan sign-off 850 is provided for ensuring that a plan is in place to transition from the present system to the new system.

Turning now to the software design methodology element 822, a user process narrative sign-off 852, an application setup configuration sign-off 854, a design security profiles sign-off 856, and a design acceptance certificate858 are each provided to ensure that adequate and accurate information regarding the design of the software being developed is provided prior to review.

Referring to the global development methodology element 824, a perform conversion data mapping sign-off 860, a design database extensions sign-off 862, and a produce module functional and technical designs sign-off 864 are each provided to ensure that the development methodology has properly included each of the above features. Turning now to the enterprise architecture methodology element 826, various associated sign-offs are provided to support the development of the enterprise architecture. In particular, a design a security architecture sign-off 866, a design application functional architecture sign-off 868, a develop system capacity plan sign-off 870, an assess performance risks sign-off 872 and a design system management sign-off 874 are each provided to ensure that proper development and documentation of each of these items has been performed prior to tollgate approval.

Turning now to the testing methodology element 826, there is provided a plurality of sign-offs relating to the completion of any needed testing development. In particular, a develop testing strategy sign-off 876, a develop unit test scripts sign-off 878, a develop system test scripts sign-off 880, a develop system integration test scripts sign-off 882, a create performance test scripts sign-off 884, and a design performance test data design sign-off 886 are each provided.

Referring now to the support methodology element 828, a design product support infrastructure sign-off 888 and a software version control (source code) sign-off 890 are provided for ensuring that the properly type of support design and documentation is completion. Regarding the peer review methodology element 830, a software design sign-off 892, an architecture sign-off 894 and a test plans sign-off 896 are provided for ensuring that proper peer review the project methodology has been established.

As above, in addition to hyperlinks directing users to templates relating to the various methodology elements and sign-offs, additional hyperlinks illustrated generally at numeral 898 may be utilized to direct users to additional information helpful in completing the various method steps. One suitable type of information may include examples of properly completed documents.

A third discrete section of the tollgate 4 web page 800 is a Review Questions section 899. This section is dedicated to itemizing a plurality of tollgate specific questions that should be asked by reviewers prior to approving the tollgate. In the embodiment of FIG. 8, the following review questions are stated: What are the critical path activities and risks, and how are we controlling them?Are Resources & Schedule still sufficient & reasonable?; Was the MGP revised based on fit & gap analysis?; Review the Risk Matrix, Risk Scorecards, Abatement Plans; Have additional ‘gaps’ been identified based upon Six Sigma and is a clear plan in place for resolution?; Was general accounting or audit involved in defining Audit & Control requirements?; Have operational changes been built & prepared?Have key users accepted and validated the changes?; Was a design review meeting between business analysts, key users & module designers held and final sign-off procured?; What legacy systems were mapped to the new application and were functional team members involved?; Is the Test Plan exhaustive and clearly written?; Has Unit Testing rigor been est. and reviewed by IF Leaders?; Has rigorous testing been conducted at all program levels for all program areas?; Did functional users extensively participate in conference room pilot and sign off on all areas of functionality?; and Is there a well managed change control system?.

Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

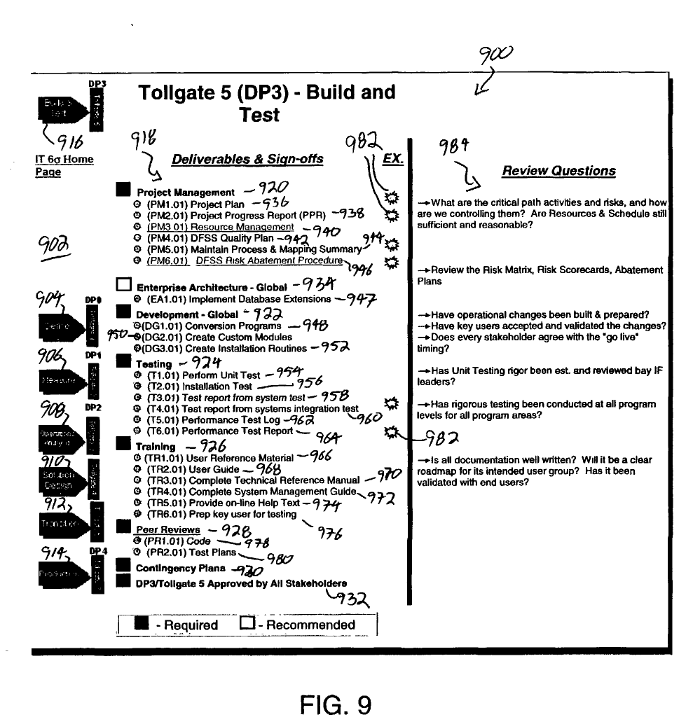

Referring now to FIG. 9, there is shown a screen shot illustrating one embodiment of a tollgate 5—specific web page 900 for displaying interactive information relating to stage 308 described briefly above. As referenced above, the tollgate 5 web page 900 is displayed in response to the selection of hyperlink 412 of the general project management methodology and tollgate selection web page 400.

In the embodiment of FIG. 9, there are displayed several discrete sections collectively enabling users to follow the methodology related to tollgate 5. The left side navigation bar 902 is provided for enabling users to easily move between web pages relating to the various tollgates 1-7. Selection of tollgates is made by selecting hyperlinked images 904-914 relating to each of the remaining 7 tollgate choices. In the displayed embodiment, an image 916 representative of the currently selected tollgate is presented at the top of the bar.

As above, a deliverables and sign-offs section 918 is also provided on web page 900 for itemizing a plurality of required and recommended methodology options. In accordance with the displayed embodiment of the present invention, the following methodology elements are required in performing the program management methodology: project management 920, global development 922, testing 924, training 926, peer review 928, contingency plans 930, and tollgate approval 932. Additionally, a global enterprise architecture element 934, although not required, is also recommended for completion in furtherance of the overall methodology goals.

In addition to the discrete methodology elements described above, each element also typically includes at least one sign-off document related thereto, wherein the sign-off documents are completed and forwarded to a tollgate approval team prior to advancing to the next tollgate. For the project management element 920, a project plan (PP) sign-off 936 is provided relating specifically to the formation, completion, or updating of a properly formatted PP. Next, a project progress report (PPR) sign-off 938 is provided for requiring the completion or update of a PPR.

A resource management sign-off 940 is provided relating to establishing a organizational plan for managing resources for the project. A hyperlink associated with the sign-off 940 preferably directs users to a template for such a plan. Next, a DFSS quality plan sign-off 942 is next provided directed to preparing or update a DFSS quality plan for enabling users and tollgate reviewers to easily identify the six sigma plans for the present project. Next, a multi-generational project plan (MGPP) sign-off 944 is provided relating to the creation of a project plan specifying various stages of release. A hyperlink associated with the MGPP sign-off directs users to a MGPP template. A DFSS risk abatement procedure sign-off 946 is provided for establishing or updating a risk abatement procedure. An associated hyperlink directs users to a risk abatement template document for aiding in the creation/update of such a procedure.

Turning now to the enterprise architecture methodology element 934, an implement database extensions sign-off 947 is preferably provided. Referring to the global development methodology element 922, a conversion programs sign-off 948, a create custom modules sign-off 950, and a create installation routines sign-off 952 are each provided to ensure that the development methodology has properly included each of the above features.

Turning now to the testing methodology element 924, there is provided a plurality of sign-offs relating to the completion of any needed testing development and performance. In particular, a perform unit test sign-off 954, an installation test sign-off 956, a test report from system test sign-off 958, test report from systems integration test sign-off 960, a performance test log sign-off 962, and a performance test report sign-off 964 are each provided.

Referring now to the training methodology element 926, a user reference material sign-off 966, a user guide sign-off 968, a complete technical reference manual sign-off 970, a complete system management guide sign-off 972, a provide on-line help text sign-off 974 and a prepare key user for testing sign-off 976 are each provided for ensuring that information regarding training materials and processes for each of these elements has been satisfactorily completed.

Regarding the peer review methodology element 928, code and test plans sign-offs 978 and 980, respectively, are provided for ensuring that proper peer review the project methodology has been established and completed.

As above, in addition to hyperlinks directing users to templates relating to the various methodology elements and sign-offs, additional hyperlinks illustrated generally at numeral 982 may be utilized to direct users to additional information helpful in completing the various method steps. One suitable type of information may include examples of properly completed documents.

A third discrete section of the tollgate 5 web page 900 is a Review Questions section 984. This section is dedicated to itemizing a plurality of tollgate specific questions that should be asked by reviewers prior to approving the tollgate. In the embodiment of FIG. 9, the following review questions are stated: What are the critical path activities and risks, and how are we controlling them?Are Resources & Schedule still sufficient and reasonable?; Review the Risk Matrix, Risk Scorecards, Abatement Plans; Have operational changes been built & prepared?; Have key users accepted and validated the changes?; Does every stakeholder agree with the “go live” timing?; Has Unit Testing rigor been est. and reviewed bay IF leaders?; Has rigorous testing been conducted at all program levels for all program areas?; and Is all documentation well written?Will it be a clear roadmap for its intended user group? Has it been validated with end users? Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

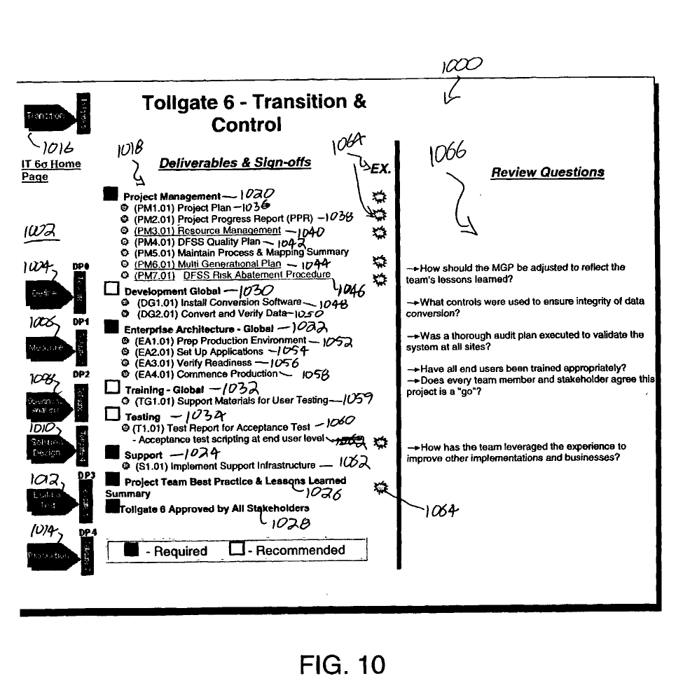

Referring now to FIG. 10, there is shown a screen shot illustrating one embodiment of a tollgate 6—specific web page 1000 for displaying interactive information relating to stage 310 described briefly above. As referenced above, the tollgate 6 web page 1000 is displayed in response to the selection of hyperlink 414 of the general project management methodology and tollgate selection web page 400.

In the embodiment of FIG. 10, there are displayed several discrete sections collectively enabling users to follow the methodology related to tollgate 6. The left side navigation bar 1002 is provided for enabling users to easily move between web pages relating to the various tollgates 1-7. Selection of tollgates is made by selecting hyperlinked images 1004-1014 relating to each of the remaining 7 tollgate choices. In the displayed embodiment, an image 1016 representative of the currently selected tollgate is presented at the top of the bar.

As above, a deliverables and sign-offs section 1018 is also provided on web page 1000 for itemizing a plurality of required and recommended methodology options. In accordance with the displayed embodiment of the present invention, the following methodology elements are required in performing the program management methodology: project management 1020, global enterprise architecture 1022, support 1024, project team best practice and lessons learned summary 1026, and tollgate approval 1028. Additionally, a global development element 1030, a training element 1032 and a testing element 1034, although not required, are also recommended for completion in furtherance of the overall methodology goals.

In addition to the discrete methodology elements described above, each element also typically includes at least one sign-off document related thereto, wherein the sign-off documents are completed and forwarded to a tollgate approval team prior to advancing to the next tollgate. For the project management element 1020, a project plan (PP) sign-off 1036 is provided relating specifically to the formation, completion, or updating of a properly formatted PP. Next, a project progress report (PPR) sign-off 1038 is provided for requiring the completion or update of a PPR.

A resource management sign-off 1040 is provided relating to establishing or updating an organizational plan for managing resources for the project. A hyperlink associated with the sign-off 1040 preferably directs users to a template for such a plan. Next, a DFSS quality plan sign-off 1042 is next provided directed to preparing or update a DFSS quality plan for enabling users and tollgate reviewers to easily identify the six sigma plans for the present project. Next, a multi-generational project plan (MGPP) sign-off 1044 is provided relating to the creation of a project plan specifying various stages of release. A hyperlink associated with the MGPP sign-off directs users to a MGPP template. A DFSS risk abatement procedure sign-off 1046 is provided for establishing or updating a risk abatement procedure. An associated hyperlink directs users to a risk abatement template document for aiding in the creation/update of such a procedure.

Regarding the global development methodology element 1030, there is preferably provided an install conversion software sign-off 1048 and a convert and verify data sign-off 1050 relating to the process of converting from a prior system to the system of the current project.

For the enterprise architecture methodology element 1022, several sign-offs are included regarding the process of establishing and initiating production of the developed project. In particular, a prepare production environment sign-off 1052, a set up applications sign-off 1054, a verify readiness sign-off 1056, and a commence production sign-off 1058 are each preferably provided.

Referring now to the training methodology element 1032, a support materials for user testing sign-off 1058 is provided for ensuring that information regarding training materials and processes for each of these elements has been satisfactorily completed. Regarding the testing methodology element 1034, there is provided a test report for acceptance test sign-off 1060.

Turning to the support methodology element 1024, an implement support infrastructure sign-off 1062 is provided for ensuring the establishment and initiation of the project's support infrastructure.

As above, in addition to hyperlinks directing users to templates relating to the various methodology elements and sign-offs, additional hyperlinks illustrated generally at numeral 1064 may be utilized to direct users to additional information helpful in completing the various method steps. One suitable type of information may include examples of properly completed documents.

A third discrete section of the tollgate 6 web page 1000 is a Review Questions section 1066. This section is dedicated to itemizing a plurality of tollgate specific questions that should be asked by reviewers prior to approving the tollgate. In the embodiment of FIG. 10, the following review questions are stated: How should the MGP be adjusted to reflect the team's lessons learned?; What controls were used to ensure integrity of data conversion?; Was a thorough audit plan executed to validate the system at all sites?; Have all end users been trained appropriately?; Does every team member and stakeholder agree this project is a “go”?; and How has the team leveraged the experience to improve other implementations and businesses?Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

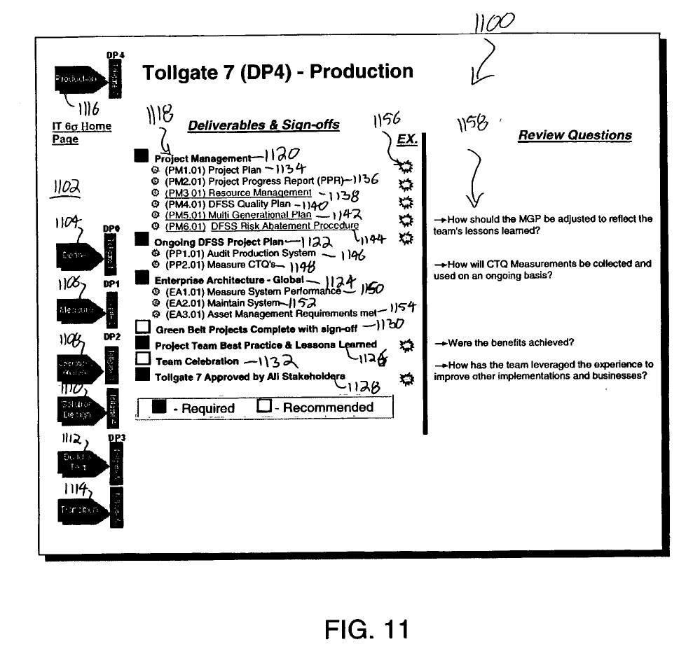

Referring now to FIG. 11, there is shown a screen shot illustrating one embodiment of a tollgate 7—specific web page 1100 for displaying interactive information relating to stage 312 described briefly above. As referenced above, the tollgate 7 web page 1000 is displayed in response to the selection of hyperlink 416 of the general project management methodology and tollgate selection web page 400.

In the embodiment of FIG. 11, there are displayed several discrete sections collectively enabling users to follow the methodology related to tollgate 7. The left side navigation bar 1102 is provided for enabling users to easily move between web pages relating to the various tollgates 1-7. Selection of tollgates is made by selecting hyperlinked images 1104-1114 relating to each of the remaining 7 tollgate choices. In the displayed embodiment, an image 1116 representative of the currently selected tollgate is presented at the top of the bar.

As above, a deliverables and sign-offs section 1118 is also provided on web page 1100 for itemizing a plurality of required and recommended methodology options. In accordance with the displayed embodiment of the present invention, the following methodology elements are required in performing the program management methodology: project management 1120, ongoing DFSS project plan 1122, global enterprise architecture 1124, project team best practice and lessons learned summary 1126, and tollgate approval 1128. Additionally, a green belt projects completed with sign-off element 1130, a team celebration element 1132, although not required, are also recommended for completion in furtherance of the overall methodology goals.

In addition to the discrete methodology elements described above, each element also typically includes at least one sign-off document related thereto, wherein the sign-off documents are completed and forwarded to a tollgate approval team prior to advancing to the next tollgate. For the project management element 1120, a project plan (PP) sign-off 1134 is provided relating specifically to the formation, completion, or updating of a properly formatted PP. Next, a project progress report (PPR) sign-off 1136 is provided for requiring the completion or update of a PPR.

A resource management sign-off 1138 is provided relating to establishing or updating an organizational plan for managing resources for the project. A hyperlink associated with the sign-off 1138 preferably directs users to a template for such a plan. Next, a DFSS quality plan sign-off 1140 is next provided directed to preparing or update a DFSS quality plan for enabling users and tollgate reviewers to easily identify the six sigma plans for the present project. Next, a multi-generational project plan (MGPP) sign-off 1142 is provided relating to the creation of a project plan specifying various stages of release. A hyperlink associated with the MGPP sign-off directs users to a MGPP template. A DFSS risk abatement procedure sign-off 1144 is provided for establishing or updating a risk abatement procedure. An associated hyperlink directs users to a risk abatement template document for aiding in the creation/update of such a procedure.

Regarding the ongoing DFSS project plan element 1122, there is preferably provided an audit production system sign-off 1146 relating to ensuring that a post-production commencement audit of the production system has been performed. Additionally, a measure CTQ's sign-off 1148 is provided relating to measurements of the original project CTQ's.

For the enterprise architecture methodology element 1124, several sign-offs are included regarding the process of producing the developed project. In particular, a measure system performance sign-off 1150, a maintain system sign-off 1152, and an asset management requirements sign-off 1154 are each preferably provided.

As above, in addition to hyperlinks directing users to templates relating to the various methodology elements and sign-offs, additional hyperlinks illustrated generally at numeral 1156 may be utilized to direct users to additional information helpful in completing the various method steps. One suitable type of information may include examples of properly completed documents.

A third discrete section of the tollgate 6 web page 1100 is a Review Questions section 1158. This section is dedicated to itemizing a plurality of tollgate specific questions that should be asked by reviewers prior to approving the tollgate. In the embodiment of FIG. 11, the following review questions are stated: How should the MGP be adjusted to reflect the team's lessons learned?; How will CTQ Measurements be collected and used on an ongoing basis?; Were the benefits achieved?; and How has the team leveraged the experience to improve other implementations and businesses? Of course, it should be understood that the above listing is exemplary only and modifications and additions to this list are clearly within the scope of the present invention. By providing a listing of questions which should be answered prior to tollgate approval, the present system better ensures that all information that should be considered is actually considered prior to approval.

By providing a uniform process for developing and implementing a new computer software application, the system and method of the present invention substantially decreases the likelihood of errors being made which introduce costs in both time, resources, and risk. Further, the present system, through its comprehensive, global nature, substantially increases the ability for distributed locations to stay in tune with what each other are doing. Because all locations must develop applications in accordance with the above-described system, added consistency results.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for facilitating IT project development, comprising the steps of:
determining whether an IT project should be developed;
receiving IT project information relating to the IT project;
completing process steps for a plurality of required checklist items in a current stage, wherein the project development process includes a plurality of IT project development stages;
requesting tollgate approval for the current stage;
determining, for the current stage, whether the tollgate approval has been obtained and the IT project process should advance from the current stage to a next stage; and
advancing to the next stage if it is determined that the tollgate approval has been obtained for the current stage.

2. The method of claim 1, further comprising the steps of:
progressing through a first stage relating to project definition;
progressing through a second stage relating to project measurement;
progressing through a third stage relating to operational analysis;
progressing through a fourth stage relating to solution design;
progressing through a fifth stage relating to building and testing;
progressing through a sixth stage relating to transitioning to the new system; and
progressing through a seventh stage relating to production issues.

3. The method of claim 2, wherein the step of progressing through a first stage relating to project definition further comprises the steps of:
determining whether a first stage tollgate should be passed; and
permitting advancement to the second stage if it is determined that the first stage tollgate has been passed.

4. The method of claim 3, wherein the step of progressing through a first stage, further comprises the steps of:
completing a mission statement methodology element;
completing a cost/benefit analysis and budget sign-off methodology element;
completing a work management methodology element;
completing a resource management methodology element; and
completing a risk assessment methodology element,
wherein each of the mission statement, cost/benefit analysis, work management, resource management, and risk assessment methodology elements further comprise discrete sign-offs relating to tasks and documentation relating the respective methodology elements.

5. The method of claim 2, wherein the step of progressing through a second stage further comprises the steps of:
determining whether a second stage tollgate should be passed; and
permitting advancement to the third stage if it is determined that the second stage tollgate has been passed.

6. The method of claim 5, wherein the step of progressing through a second stage, further comprises the steps of:
completing a process maps, requirements and sign-off methodology element;
completing a CTQ and critical process prioritization methodology element;
completing a resource, schedule and scorecard status methodology element;
completing a cost/benefit analysis and budget sign-off methodology element; and
completing a definition of green belt projects methodology element,
wherein each of the process maps, CTQ and critical process prioritization, resource, schedule and scorecard status, cost/benefit analysis, and definition of green belt projects methodology elements further comprise discrete sign-offs relating to tasks and documentation relating the respective methodology elements.

7. The method of claim 2, wherein the step of progressing through a third stage further comprises the steps of:
determining whether a third stage tollgate should be passed; and
permitting advancement to the fourth stage if it is determined that the third stage tollgate has been passed.

8. The method of claim 7, wherein the step of progressing through a third stage, further comprises the steps of:
completing a project management methodology element;
completing a fit and gap analysis methodology element; and
completing a defect ranking methodology element,
wherein each of the project management, fit and gap analysis, and defect ranking methodology elements further comprise discrete sign-offs relating to tasks and documentation relating the respective methodology elements.

9. The method of claim 2, wherein the step of progressing through a fourth stage further comprises the steps of:
determining whether a fourth stage tollgate should be passed;
permitting advancement to the fifth stage if it is determined that the fourth stage tollgate has been passed.

10. The method of claim 9, wherein the step of progressing through a fourth stage, further comprises the steps of:
completing a project management methodology element;
completing a software design methodology element;
completing a global development methodology element;
completing an enterprise architecture methodology element;
completing a testing methodology element;
completing a support methodology element; and
completing a peer reviews methodology element,
wherein each of the project management, software design, global development, enterprise architecture, testing, support, and peer reviews methodology elements further comprise discrete sign-offs relating to tasks and documentation relating the respective methodology elements.

11. The method of claim 2, wherein the step of progressing through a fifth stage further comprises the steps of:
determining whether a fifth stage tollgate should be passed; and
permitting advancement to the sixth stage if it is determined that the fifth stage tollgate has been passed.

12. The method of claim 11, wherein the step of progressing through a fifth stage, further comprises the steps of:
completing a project management methodology element;
completing a global development methodology element;
completing a testing methodology element;
completing a training methodology element;
completing a peer reviews methodology element; and
completing a contingency plans methodology element,
wherein each of the project management, global development, testing, training, peer reviews, and contingency plans methodology elements further comprise discrete sign-offs relating to tasks and documentation relating the respective methodology elements.

13. The method of claim 2, wherein the step of progressing through a sixth stage further comprises the steps of:
determining whether a sixth stage tollgate should be passed; and
permitting advancement to the seventh stage if it is determined that the sixth stage tollgate has been passed.

14. The method of claim 13, wherein the step of progressing through a sixth stage, further comprises the steps of:
completing a project management methodology element;
completing an enterprise architecture methodology element;
completing a support methodology element; and
completing a project team best practice and lessons learned methodology element,
wherein each of the project management, enterprise architecture, support, and project team best practice and lessons learned methodology elements further comprise discrete sign-offs relating to tasks and documentation relating the respective methodology elements.

15. The method of claim 2, wherein the step of progressing through a seventh stage further comprises the steps of:
determining whether a seventh stage tollgate should be passed indicating; and
maintaining production if it is determined that the seventh stage tollgate has been passed.

16. The method of claim 15, wherein the step of progressing through a seventh stage, further comprises the steps of:
completing a project management methodology element;
completing an ongoing DFSS project plan methodology element; and
completing an enterprise architecture methodology element; and
completing a project team best practice and lessons learned methodology element,
wherein each of the project management, ongoing DFSS project plan, enterprise architecture, and project team best practice and lessons learned methodology elements further comprise discrete sign-offs relating to tasks and documentation relating the respective methodology elements.

17. A system for facilitating development of IT projects, comprising:
a server computer system for maintaining and serving a plurality of web pages relating to a project development methodology;
a client computer system associated with participants in a project and operatively connected to the server computer system over a computer network;
means for receiving a request from the client computer system to display a general project management methodology and tollgate selection web page;
means for displaying the requested general project management methodology and tollgate selection web page;
means for receiving a request from the client computer to display a selected one of several tollgate-specific web pages; and
means for displaying the requested tollgate specific web page.

18. The system of claim 17, wherein the general project management methodology and tollgate selection web page is configured to include a description of the project management methodology and hyperlinks to a plurality of tollgate specific web pages.

19. The system of claim 18, wherein the means for receiving a request to display a selected one of several tollgate-specific web pages, further comprises means for receiving a request to display a tollgate 1—specific web page relating to project definition.

20. The system of claim 19, wherein the tollgate 1—specific web page comprises:
a deliverables and sign-offs section including a plurality of methodology elements to be addressed prior to tollgate review and advancement to tollgate 2; and
a review questions section including a listing of questions to be answered during the fulfillment of any required tollgate 1 methodology elements.

21. The system of claim 20, wherein the plurality of methodology elements may each further include sign-offs more specifically related to particular tasks for completion.

22. The system of claim 21, wherein the tollgate 1—specific web page further includes a plurality of hyperlinks associated with sign-offs, for directing users to template documents, example documents or guides assisting in the completion of the related task.

23. The system of claim of claim 20, wherein the plurality of methodology elements, comprise:
a mission statement methodology element;
a cost/benefit analysis and budget sign-off methodology element;
a work management methodology element;
a resource management methodology element; and
a risk assessment methodology element.

24. The system of claim 18, wherein the means for receiving a request to display a selected one of several tollgate-specific web pages, further comprises means for receiving a request to display a tollgate 2—specific web page relating to project measurements.

25. The system of claim 24, wherein the tollgate 2—specific web page comprises:
a deliverables and sign-offs section including a plurality of methodology elements to be addressed prior to tollgate review and advancement to tollgate 3; and
a review questions section including a listing of questions to be answered during the fulfillment of any required tollgate 2 methodology elements.

26. The system of claim 25, wherein the plurality of methodology elements may each further include sign-offs more specifically related to particular tasks for completion.

27. The system of claim 26, wherein the tollgate 2—specific web page further includes a plurality of hyperlinks associated with sign-offs, for directing users to template documents, example documents or guides assisting in the completion of the related task.

28. The system of claim of claim 25, wherein the plurality of methodology elements, comprise:
a process maps, requirements and sign-off methodology element;
a CTQ and critical process prioritization methodology element;
a resource, schedule and scorecard status methodology element;
a cost/benefit analysis and budget sign-off methodology element; and
a definition of green belt projects methodology element.

29. The system of claim 18, wherein the means for receiving a request to display a selected one of several tollgate-specific web pages, further comprises means for receiving a request to display a tollgate 3—specific web page relating to operational analysis.

30. The system of claim 29, wherein the tollgate 3—specific web page comprises:
a deliverables and sign-offs section including a plurality of methodology elements to be addressed prior to tollgate review and advancement to tollgate 4; and
a review questions section including a listing of questions to be answered during the fulfillment of any required tollgate 3 methodology elements.

31. The system of claim 30, wherein the plurality of methodology elements may each further include sign-offs more specifically related to particular tasks for completion.

32. The system of claim 31, wherein the tollgate 3—specific web page further includes a plurality of hyperlinks associated with sign-offs, for directing users to template documents, example documents or guides assisting in the completion of the related task.

33. The system of claim of claim 30, wherein the plurality of methodology elements, comprise:
a project management methodology element;
a fit and gap analysis methodology element; and
a defect ranking methodology element.

34. The system of claim 18, wherein the means for receiving a request to display a selected one of several tollgate-specific web pages, further comprises means for receiving a request to display a tollgate 4—specific web page relating to solution design.

35. The system of claim 34, wherein the tollgate 4—specific web page comprises:
a deliverables and sign-offs section including a plurality of methodology elements to be addressed prior to tollgate review and advancement to tollgate 5; and
a review questions section including a listing of questions to be answered during the fulfillment of any required tollgate 4 methodology elements.

36. The system of claim 35, wherein the plurality of methodology elements may each further include sign-offs more specifically related to particular tasks for completion.

37. The system of claim 36, wherein the tollgate 4—specific web page further includes a plurality of hyperlinks associated with sign-offs, for directing users to template documents, example documents or guides assisting in the completion of the related task.

38. The system of claim of claim 35, wherein the plurality of methodology elements, comprise:
a project management methodology element;
a software design methodology element;
a global development methodology element;
an enterprise architecture methodology element;
a testing methodology element;
a support methodology element; and
a peer reviews methodology element.

39. The system of claim 18, wherein the means for receiving a request to display a selected one of several tollgate-specific web pages, further comprises means for receiving a request to display a tollgate 5—specific web page relating to transition to project building and testing.

40. The system of claim 39, wherein the tollgate 5—specific web page comprises:
a deliverables and sign-offs section including a plurality of methodology elements to be addressed prior to tollgate review and advancement to tollgate 6; and
a review questions section including a listing of questions to be answered during the fulfillment of any required tollgate 5 methodology elements.

41. The system of claim 40, wherein the plurality of methodology elements may each further include sign-offs more specifically related to particular tasks for completion.

42. The system of claim 41, wherein the tollgate 5—specific web page further includes a plurality of hyperlinks associated with sign-offs, for directing users to template documents, example documents or guides assisting in the completion of the related task.

43. The system of claim of claim 40, wherein the plurality of methodology elements, comprise:
a project management methodology element;
a global development methodology element;
a testing methodology element;
a training methodology element;
a peer reviews methodology element; and
a contingency plans methodology element.

44. The system of claim 18, wherein the means for receiving a request to display a selected one of several tollgate-specific web pages, further comprises means for receiving a request to display a tollgate 6—specific web page relating to production issues.

45. The system of claim 44, wherein the tollgate 6—specific web page comprises:
a deliverables and sign-offs section including a plurality of methodology elements to be addressed prior to tollgate review and advancement to tollgate 7; and
a review questions section including a listing of questions to be answered during the fulfillment of any required tollgate 6 methodology elements.

46. The system of claim 45, wherein the plurality of methodology elements may each further include sign-offs more specifically related to particular tasks for completion.

47. The system of claim 46, wherein the tollgate 6—specific web page further includes a plurality of hyperlinks associated with sign-offs, for directing users to template documents, example documents or guides assisting in the completion of the related task.

48. The system of claim of claim 45, wherein the plurality of methodology elements, comprise:
a project management methodology element;
an enterprise architecture methodology element;
a support methodology element; and
a project team best practice and lessons learned methodology element.

49. The system of claim 18, wherein the means for receiving a request to display a selected one of several tollgate-specific web pages, further comprises means for receiving a request to display a tollgate 7—specific web page relating to project measurements.

50. The system of claim 49, wherein the tollgate 7—specific web page comprises:
a deliverables and sign-offs section including a plurality of methodology elements to be addressed prior to tollgate review; and
a review questions section including a listing of questions to be answered during the fulfillment of any required tollgate 7 methodology elements.

51. The system of claim 50, wherein the plurality of methodology elements may each further include sign-offs more specifically related to particular tasks for completion.

52. The system of claim 51, wherein the tollgate 7—specific web page further includes a plurality of hyperlinks associated with sign-offs, for directing users to template documents, example documents or guides assisting in the completion of the related task.

53. The system of claim of claim 50, wherein the plurality of methodology elements, comprise:
a project management methodology element;
an ongoing DFSS project plan methodology element; and
an enterprise architecture methodology element; and
a project team best practice and lessons learned methodology element.
